(19) United States
(12) Patent Application Publication
(10) Pub. No.: US 2015/0020448 A1
(43) Pub. Date: Jan. 22, 2015

(54) METHOD FOR FORMING ORNAMENTAL TREE BY PRUNING AND INDUCING GROWTH OF BRANCHES

(71) Applicants: Tae-Soo Park, (US); SUNGSIHWA LANDS CAPE ARCHECTURE CO., LTD., Daejeon (KR)

(72) Inventor: Tae-Soo Park, Chungcheongbuk-do (KR)

(73) Assignees: Tae-Soo Park; SUNGSIHWA LANDS CAPE ARCHECTURE CO., LTD.

(21) Appl. No.: 14/509,318

(22) Filed: Oct. 8, 2014

Related U.S. Application Data
(63) Continuation of application No. PCT/KR2012/007727, filed on Sep. 26, 2012.

(30) Foreign Application Priority Data
Apr. 10, 2012 (KR) 10-2012-0037510

(51) Int. Cl. A01G 23/02; A01G 1/00

(52) U.S. Cl. CPC A01G 23/02; A01G 1/001
USPC 47/58.1 R

(57) ABSTRACT

A method for forming an ornamental tree by pruning and inducing growth of branches, which appears to grow after being compressed by snow and then be compressed again by snow, appears to grow into a new form by barely remaining persistent life force in a stem after being bent by lightning, appears to be bent by the wind and grow in a direction of the wind after growing in the face of the wind, branches of which appears to be spread endlessly toward a space on a cliff to make their space, which appears to grow on a rock while overcoming the environment, appears to grow in a landslide area carried off by sudden heavy rain, which appears to grow out of a narrow space in which trees competitively grow, or appears to grow in a sagged shape by heavy snow.

### REFERENCE TO RELATED APPLICATIONS

This is a continuation of pending International Patent Application PCT/KR2012/007727 filed on Sep. 26, 2012, which designates the United States and claims priority of Korean Patent Application No. 10-2012-0037510 filed on Apr. 10, 2012, the entire contents of which are incorporated herein by reference.

### FIELD OF THE INVENTION

The present invention relates to a method for forming an ornamental tree by pruning and inducing growth of branches. More particularly, the present invention relates to a method for forming an ornamental tree, by pruning and inducing growth of branches, which appears to grow and to be compressed again by snow after being compressed by snow, appears to grow into a new form by barely remaining persistent life force in a stem after being bent by lightning, appears to be bent by the wind and grow to a direction of the wind after growing in the face of the wind, branches of which appears to be spread endlessly toward a space on a cliff to make their space, which appears to grow on a rock while overcoming the environment, appears to grow in a landslide area carried off by sudden heavy rain, which appears to grow out of a narrow space in which trees competitively grow, or appears to sag due to heavy snow.

### BACKGROUND OF THE INVENTION

In general, branches are cut to make a tree shape mainly in fruit farming. Such work is called training and is distinguished from pruning which means weeding or cutting minor branches.

Pruning aims (1) to remove broken or weak branches having problems and to trim branches in a portion in which many branches grow, (2) to limit the number of branches which may bear fruit and to prevent many fruits from bearing, and (3) to prevent locations bearing fruits from being heightened and to prevent lower parts of trees from being empty due to many branches generated from end portions of mother branches.

Here, it is called thinning-out to cut lower parts of branches of trees, and it is called heading back to cut middle portions of branches such that healthy new branches grow. Generally, thinning-out and heading back are collectively referred to as pruning. Development, elongation and fruiting habits of branches vary according to a kind of fruit trees. Therefore, methods of pruning also vary according to a kind of fruit trees. In citrus trees, pruning is simply carried out. However, in grapevines, pruning is carried out annually on a large scale. Regardless pruning type, pruning is important work of orchards performed in winter. Through pruning, growth of actively growing trees may be suppressed and fruiting time may be delayed. Therefore, pruning is simply performed except for purpose of removing branches.

In addition, principally, pruning is more strongly carried out when trees are older. When trees are older, trees are weaker and fruiting also is weaker. Therefore, in many cases, thick branches are cut and changed into new branches in good condition by renewal pruning. Branch changing may be partially and easily renewed before trees are older. Principally, after pruning, cut portions are treated to ensure rapid healing. In thinning-out, lower parts of branches are cut horizontally. Meanwhile, in heading back, slightly higher portions than buds are cut obliquely.

As a conventional art with respect to the fruit tree pruning methods, Korean Patent No. 10-0738324 discloses a method of pruning pear trees including maintaining 3 to 4 main branches developed from trunk such that upper portions of the branches sag; heavy pruning the upper portions of the branches such that vegetative growth of the upper portion is induced; inducing water sprouts to a degree of 45° after leaving such that water sprouts grow when the main branches are bolted and then light pruning or leaving, or removing sprouts before water sprouts develop, so as to stabilize viability of trees and strengthen viability of roots; and removing competitive branches developed in the upper portions of the main branches.

A variety of ornamental trees such as herbs, shrubs, arbors and the like are planted and trained indoors, in gardens, in buildings, by the roadsides and the like for a hobby, interior decoration, landscaping, or the like. Technologies related with such landscaping and gardening have a long tradition and are developing day by day.

Pot planting is a tradition method of growing ornamental trees and shrubs. As known generally, a variety of trees shapes such as a straight shape, a crooked shape, an overhang shape, a grove shape and the like may be artificially expressed through a variety of artificial trimming processes such as thinning, pruning, disbudding, shoot cutting, leaf picking, root pruning, wire hanging and the like.

As a conventional art with respect to the above methods of forming ornamental trees, Korean Patent No. 10-0415311 discloses a method of forming shapes of ornamental trees and shrubs including: selecting a tree 10 which may express a desired tree shape and trimming a branch 11 of the tree 10 to a desired shape; fixing a tree shape frame 20 including branch guide rings 21 having a shape corresponding to the desired tree shape to the ground or a pot 30 in which the tree 10 is planted; upwardly inserting the branch 11 into the branch guide rings 21 from a lower portion of the branch 11 and inserting the branch 11 into the branch guide rings 21 to a position of just before a sharply bent portion 23 such that the branch 11 is not damaged by excessively bending the branch 11; bending and temporarily fixing the branch 11 such that the sharply bent portion 23 is not damage; completely inserting the branch 11 into the sharp bent portion 23 through repetitive processes to further bend the branch 11 after the branch 11 is bent by the temporary bending; inserting the branch 11 into all of the branch guide rings 21 by repeating inserting the branch 11 into the branch guide rings 21 to a position of just before a sharply bent portion 23 and completely inserting the branch 11 into the sharp bent portion 23 such that the branch 11 has a tree shape corresponding to the tree shape; and removing the tree shape frame 20 when a shape of the branch 11 is formed according to the desired tree shape, wherein a protector 40 is disposed between the branch 11 and the tree shape frame 20 when the branch 11 is inserted into the branch guide rings 21, and a guider 50 near the branch 11 is disposed when the branch 11 is bent.

However, main purposes of pruning methods according to conventional technologies are to help growth of fruit trees. By methods of forming shapes of ornamental trees and shrubs, shapes of ornamental trees and shrubs are formed using tree shape frames and branch guide rings. Thus, except for pot planting, a method of forming ornamental tree only by pruning and inducing growth of landscaping tree branches is not known at all.

Accordingly, inventors of the present invention developed a method for forming an ornamental tree, which appears to be compressed by snow, appears to be formed by lightning, appears to be bent by the wind, appears to be formed in a direction of the wind, appears to be on a cliff, appears to be on a rock, appears to be formed in a landslide area, appears to grow out of a narrow space in which trees competitively grow, appears to be formed by heavy snow, viability of which appears to be deteriorated, in which flow of sap appears to be stopped, and in which nutrients appear to be are collected in a stem, thus completing the present invention.

### SUMMARY OF THE INVENTION

Therefore, the present invention has been made in view of the above problems, and it is an object of the present invention to provide a method for forming an ornamental tree, by pruning and inducing the growth of branches of seedlings or adult trees, having branches which appear to be compressed by snow, having branches which appear to be formed by lightning, having branches which appear to be bent by the wind, having branches which appear to be formed in a direction of the wind, having branches which appear to grow on a cliff, having branches which appear to grow on a rock, having branches which appear to grow in a landslide area, having branches which appear to grow out of a narrow space in which trees competitively grow, having branches which appear to be formed by heavy snow, having branches of which viability appears to be deteriorated, having branches of which sap flow appears to be stopped, and having branches of which nutrients appear to be collected in a stem.

In accordance with an aspect of the present invention, the above and other objects can be accomplished by the provision of a method of forming an ornamental tree having a branch shape which appears to be pressed by snow, an ornamental tree having a branch shape which appears to be struck by lightning, an ornamental tree having a branch shape which appears to be bent by the wind, an ornamental tree having a branch, a direction of which appears to have been changed by the wind, an ornamental tree having a branch shape which appears to grow on a cliff, an ornamental tree having a branch shape which appears to grow on a rock, an ornamental tree having a branch shape which appears to grow in a landslide area, an ornamental tree having a branch shape which appears to grow out of a narrow space in which trees competitively grow, an ornamental tree having a branch shape which appears to sag due to heavy snow, an ornamental tree having a [symbol] -shape or [symbol] shape branch, viability of which appears to be weakened, an ornamental tree having a [symbol] -shape, sap flow of which appears to be stopped, or an ornamental tree having a [symbol] -shape branch of which nutrients appear to be collected in a stem by the first pruning to prune while leaving branches toward any one direction or alternately leaving branches toward crossing directions; first branch growth inducing to induce growth of the other branches in any one of upper, lower, front, rear, left and right directions after the first pruning; second pruning to prune branches while leaving branches in one direction of branches developed from branches toward one direction growth-induced in the first branch growth; second branch growth inducing to induce growth of the left branches in any one of upper, lower, front, rear, left and right directions after the second pruning; and sequentially repeating the second pruning and the second branch growth inducing one time or more after the second branch growth inducing, after inducing growth of branches developed from horizontal, vertical or inclined branches of a sapling or adult tree in an original direction or in any one direction.

In accordance with another aspect of the present invention, provided herein is a method of forming an ornamental tree having a branch shape which appears to be pressed by snow by pruning and inducing growth of branches including: first pruning to prune branches while leaving downwardly growing branches among branches developed from horizontal branches of a sapling or adult tree; first branch growth inducing to downwardly induce growth of the downwardly growing branches left after the first pruning; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to downwardly induce growth of the left-side growing branches left after the third pruning; fourth pruning to prune branches while leaving upwardly growing branches among branches developed from the downwardly growing branches growth-induced by the third branch growth inducing; and fourth branch growth inducing to upwardly induce growth of the upwardly growing branches left after the fourth pruning.

In accordance with a further aspect of the present invention, provided herein is a method of forming an ornamental tree having a branch shape which appears to be bent due to lightning by pruning and inducing growth of branches including: first pruning to prune branches while leaving branches growing to the left side of branches developed from vertical branches of a sapling or adult tree; first branch growth inducing to downwardly induce growth of the left-side growing branches left after the first pruning; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to downwardly induce growth of the left-side growing branches left after the third pruning; fourth pruning to prune branches while leaving left-side growing branches among branches developed from the downwardly growing branches growth-induced by the third branch growth inducing; and fourth branch growth inducing to upwardly induce growth of the left-side growing branches left after the fourth pruning.

In accordance with a further aspect of the present invention, provided herein is a method of forming an ornamental tree having a branch shape which appears to be bent by the wind by pruning and inducing growth of branches including: first pruning to prune branches while leaving upwardly growing branches among branches developed from horizontal branches of a sapling or adult tree; first branch growth inducing to upwardly induce growth of the upwardly growing branches left after the first pruning; second pruning to prune branches while leaving branches growing to the right side among branches developed from the upwardly growing branches growth-induced by the first branch growth inducing; second branch growth inducing to induce growth of the right-side growing branches left after the second pruning to the right side; third pruning to prune branches while leaving downwardly growing branches among branches developed from the right-side growing branches growth-induced by the second branch growth inducing; third branch growth inducing including third branch growth inducing to downwardly induce growth of the downwardly growing branches left after the third pruning; fourth pruning to prune branches while leaving branches growing to the right side among branches developed from the downwardly growing branches growth-induced by the third branch growth inducing; and fourth branch growth inducing to induce growth of the right-side growing branches left after the fourth pruning to the right side.

In accordance with a further aspect of the present invention, provided herein is a method of forming an ornamental tree having a branch, a direction of which appears to have been changed by the wind by pruning and inducing growth of branches including: first pruning to prune branches while leaving upwardly growing branches among branches developed from horizontal branches of a sapling or adult tree; first branch growth inducing to induce growth of the upwardly growing branches left after the first pruning in a leftwardly and upwardly inclined direction; second pruning to prune while leaving branches growing to the right side among branches developed from the leftwardly and upwardly inclined branches growth-induced by the first branch growth inducing; second branch growth inducing to induce growth of the right-side growing branches left after the second pruning in a rightwardly and upwardly inclined direction; third pruning to prune branches while leaving downwardly growing branches among branches developed from the rightwardly and upwardly inclined branches growth-induced by the second branch growth inducing; third branch growth inducing to induce growth of the downwardly growing branches left after the third pruning to the right side; fourth pruning to prune branches while leaving upwardly growing branches among branches developed from the right-side growing branches growth-induced by the third branch growth inducing; fourth branch growth inducing to induce growth of the upwardly growing branches left after the fourth pruning in a rightwardly and upwardly inclined direction; fifth pruning to prune branches while leaving downwardly growing branches among branches developed from the rightwardly and upwardly inclined branches growth-induced by the fourth branch growth inducing; fifth branch growth inducing to induce growth of the downwardly growing branches left after the fifth pruning to the right side; a sixth pruning to prune branches while leaving downwardly growing branches among branches developed from the right-side growing branches growth-induced by the fifth branch growth inducing; sixth branch growth inducing to induce growth of the downwardly growing branches left after the sixth pruning in a rightwardly and downwardly inclined direction; a seventh pruning to prune branches while leaving upwardly growing branches among branches developed from the rightwardly and downwardly inclined branches growth-induced by the sixth branch growth inducing; and seventh branch growth inducing to induce growth of the upwardly growing branches left after the seventh pruning to the right side.

In accordance with a further aspect of the present invention, provided herein is a method of forming an ornamental tree having a branch shape which appears to grow on a cliff by pruning and inducing growth of branches including: first pruning to prune branches while leaving downwardly growing branches among branches developed from horizontal branches of a sapling or adult tree; first branch growth inducing to induce growth of the downwardly growing branches left after the first pruning in a leftwardly and downwardly inclined direction; second pruning to prune branches while leaving branches growing to the right side among branches developed from the leftwardly and downwardly inclined branches growth-induced by the first branch growth inducing; second branch growth inducing to downwardly induce growth of the right-side growing branches left after the second pruning; third pruning to prune branches while leaving left-side growing branches among branches developed from the downwardly growing branches growth-induced by the second branch growth inducing; third branch growth inducing to induce growth of the left-side growing branches left after the third pruning in a leftwardly and downwardly inclined direction; fourth pruning to prune branches while leaving branches growing to the right side among branches developed from the leftwardly and downwardly inclined branches growth-induced by the third branch growth inducing; fourth branch growth inducing to downwardly induce growth of the right-side growing branches left after the fourth pruning; fifth pruning to prune branches while leaving left-side growing branches among branches developed from the downwardly growing branches growth-induced by the fourth branch growth inducing; and fifth branch growth inducing to induce growth of the left-side growing branches left after the fifth pruning in a leftwardly and downwardly inclined direction.

In accordance with a further aspect of the present invention, provided herein is a method of forming an ornamental tree having a branch shape which appears to grow on a rock by pruning and inducing growth of branches including: first pruning to prune branches while leaving branches growing to the left side of branches developed from vertical branches of a sapling or adult tree; first branch growth inducing to induce growth of the left-side growing branches left after the first pruning to the left side; second pruning to prune branches while leaving upwardly growing branches among branches developed from the left-side growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to induce growth of the left-side growing branches left after the third pruning to the left side; fourth pruning to prune branches while leaving upwardly growing branches among branches developed from the left-side growing branches growth-induced by the third branch growth inducing; and fourth branch growth inducing to upwardly induce growth of the upwardly growing branches left after the fourth pruning.

In accordance with a further aspect of the present invention, provided herein is a method of forming an ornamental tree having a branch shape which appears to grow in a landslide area by pruning and inducing growth of branches including: first pruning to prune branches while leaving upwardly growing branches after inducing growth of branches developed from vertical branches of a sapling or adult tree in a leftwardly and downwardly inclined direction; first branch growth inducing to upwardly induce growth of the upwardly growing branches left after the first pruning; second pruning to prune branches while leaving left-side growing branches among branches developed from the upwardly growing branches growth-induced by the first branch growth inducing; second branch growth inducing to induce growth of the left-side growing branches left after the second pruning in a leftwardly and downwardly inclined direction; third pruning to prune branches while leaving upwardly growing branches among branches developed from the leftwardly and downwardly inclined branches growth-induced by the second branch growth inducing; and third branch growth inducing to upwardly induce growth of the upwardly growing branches left after the third pruning.

In accordance with a further aspect of the present invention, provided herein is a method of forming an ornamental tree having a branch shape which appears to sag due to heavy snow by pruning and inducing growth of branches including: first pruning to prune branches while leaving downwardly growing branches after downwardly inducing growth of branches developed from vertical branches of a sapling or adult tree; first branch growth inducing to downwardly induce growth of the downwardly growing branches left after the first pruning; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving downwardly growing branches among branches developed from the upwardly growing branches growth-induced by the second branch growth inducing; third branch growth inducing to downwardly induce growth of the downwardly growing branches left after the third pruning; fourth pruning to prune branches while leaving upwardly growing branches among branches developed from the downwardly growing branches growth-induced by the third branch growth inducing; and fourth branch growth inducing to upwardly induce growth of the upwardly growing branches left after the fourth pruning.

As is apparent from the above description, a method of forming an ornamental tree by pruning and inducing growth of branches according to the present invention may form a beautifully shaped tree, may prevent development of crossing branches, may prevent branches from bending by heavy snow, may prevent damage by a gust of wind or a typhoon, may prevent disease and harmful insects by smooth air, may aid migration and settlement of birds being exterminators of harmful insects, may help branches to observe nutrients and may prevent development of weak branches by increasing a light transmission ratio, may help trees to be easily moved, may help trees to be simply moved, may reduce tree care costs, may provide expensive trees, may save tree transportation costs, and may reduce problems of transplanted trees due to development of minor roots.

### BRIEF DESCRIPTION OF THE DRAWINGS

The above and other objects, features and other advantages of the present invention will be more clearly understood from the following detailed description taken in conjunction with the companying drawings, in which:

FIG. 1 is an image illustrating forming processes of an ornamental tree having a branch shape which appears to be pressed by snow;

FIG. 2 is an image illustrating a shape of an ornamental tree having a branch shape which appears to be pressed by snow;

FIG. 3 is a photograph of an ornamental tree having a branch shape which appears to be pressed by snow;

FIG. 4 is an image illustrating forming processes of an ornamental tree having a branch shape which appears to be struck by lightning;

FIG. 5 is an image illustrating a shape of an ornamental tree having a branch shape which appears to be struck by lightning;

FIG. 6 is a photograph of an ornamental tree having a branch shape which appears to be struck by lightning;

FIG. 7 is an image illustrating forming processes of an ornamental tree having a branch shape which appears to be bent by the wind;

FIG. 8 is an image illustrating a shape of an ornamental tree having a branch shape which appears to be bent by the wind;

FIG. 9 is a photograph of an ornamental tree having a branch shape which appears to be bent by the wind;

FIG. 10 is an image illustrating forming processes of an ornamental tree having a branch, a direction of which appears to have been changed by the wind;

FIG. 11 is an image illustrating a shape of an ornamental tree having a branch, a direction of which appears to have been changed by the wind;

FIG. 12 is a photograph of an ornamental tree having a branch, a direction of which appears to have been changed by the wind;

FIG. 13 is an image illustrating forming processes of an ornamental tree having a branch shape which appears to grow on a cliff;

FIG. 14 is an image illustrating a shape of an ornamental tree having a branch shape which appears to grow on a cliff;

FIG. 15 is a photograph of an ornamental tree having a branch shape which appears to grow on a cliff;

FIG. 16 is an image illustrating forming processes of an ornamental tree having a branch shape which appears to grow on a rock;

FIG. 17 is an image illustrating a shape of an ornamental tree having a branch shape which appears to grow on a rock;

FIG. 18 is a photograph of an ornamental tree having a branch shape which appears to grow on a rock;

FIG. 19 is an image illustrating forming processes of an ornamental tree having a branch shape which appears to grow in a landslide area;

FIG. 20 is an image illustrating a shape of an ornamental tree having a branch shape which appears to grow in a landslide area;

FIG. 21 is a photograph of an ornamental tree having a branch shape which appears to grow in a landslide area;

FIG. 22 is an image illustrating forming processes of an ornamental tree having a branch shape which appears to grow out of a narrow space in which trees competitively grow;

FIG. 23 is an image illustrating a shape of an ornamental tree having a branch shape which appears to grow out of a narrow space in which trees competitively grow;

FIG. 24 is a photograph of an ornamental tree having a branch shape which appears to grow out of a narrow space in which trees competitively grow;

FIG. 25 is an image illustrating forming processes of an ornamental tree having a branch shape which appears to sag due to heavy snow;

FIG. 26 is an image illustrating a shape of an ornamental tree having a branch shape which appears to sag due to heavy snow;

FIG. 27 is a photograph of an ornamental tree having a branch shape which appears to sag due to heavy snow;

FIG. 28 is an image illustrating forming processes of an ornamental tree having [symbol] -shape or [symbol] -shape branches weakening viability of trees;

FIG. 29 is an image illustrating a shape of an ornamental tree having [symbol] -shape or [symbol] -shape branches weakening viability of trees;

FIG. 30 is a photograph of an ornamental tree having [symbol] -shape or [symbol] -shape branches weakening viability of trees;

FIG. 31 is an image illustrating forming processes of an ornamental tree having [symbol] -shape branches in which sap flow is stopped;

FIG. 32 is an image illustrating a shape of an ornamental tree having [symbol] -shape branches in which sap flow is stopped;

FIG. 33 is a photograph of an ornamental tree having [symbol] -shape branches in which sap flow is stopped;

FIG. 34 is an image illustrating forming processes of an ornamental tree having [symbol] -shape branches in which nutrients are collected in a stem;

FIG. 35 is an image illustrating a shape of an ornamental tree having [symbol] -shape branches in which nutrients are collected in a stem; and

FIG. 36 is a photograph of an ornamental tree having [symbol] -shape branches in which nutrients are collected in a stem.

### DETAILED DESCRIPTION OF THE INVENTION

Hereinafter, embodiments will be described in detail with reference to the annexed drawings for better understanding. However, it will be apparent that the embodiments may be modified in various ways and the scope of the embodiments should not be construed as being limited to the following description. Thus, the embodiments are provided to ensure more perfect comprehension of the embodiments by one of ordinary skill in the art.

First, the present invention is characterized by a method of forming an ornamental tree having a branch shape which appears to be pressed by snow, an ornamental tree having a branch shape which appears to be struck by lightning, an ornamental tree having a branch shape which appears to be bent by the wind, an ornamental tree having a branch, a direction of which appears to have been changed by the wind, an ornamental tree having a branch shape which appears to grow on a cliff, an ornamental tree having a branch shape which appears to grow on a rock, an ornamental tree having a branch shape which appears to grow in a landslide area, an ornamental tree having a branch shape which appears to grow out of a narrow space in which trees competitively grow, an ornamental tree having a branch shape which appears to sag due to heavy snow, an ornamental tree having a [symbol] -shape or [symbol] -shape branch, viability of which appears to be weakened, an ornamental tree having a [symbol] -shape, sap flow of which appears to be stopped or an ornamental tree having a [symbol] -shape branch of which nutrients appear to be collected in a stem by the first pruning to prune while leaving branches toward any one direction or alternately leaving branches toward crossing directions after inducing growth of branches developed from horizontal, vertical or inclined branches of a sapling or adult tree to an original direction or to any one direction; second pruning to prune branches while leaving branches in one direction of branches developed from branches toward one direction growth-induced in the first branch growth; second branch growth inducing to induce growth of the left branches in any one of upper, lower, front, rear, left and right directions after the second pruning; and sequentially repeating the second pruning and the second branch growth inducing one time or more after the second branch growth inducing.

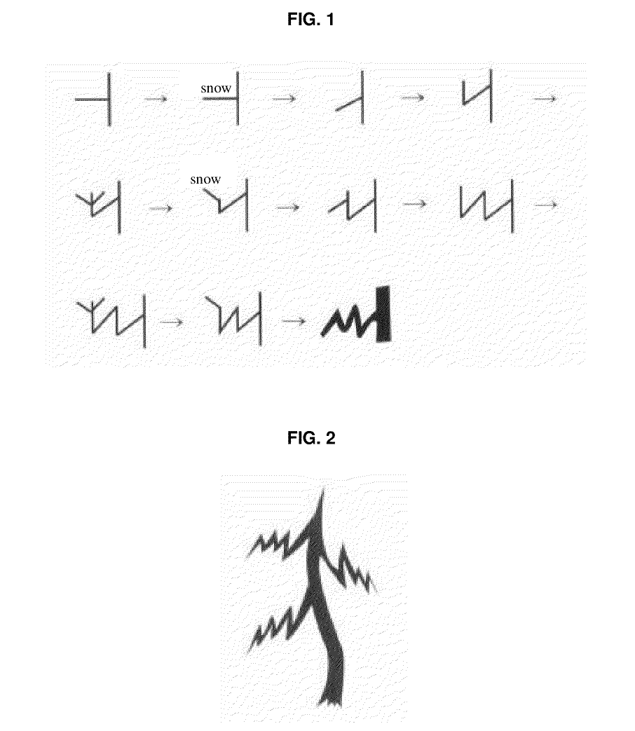

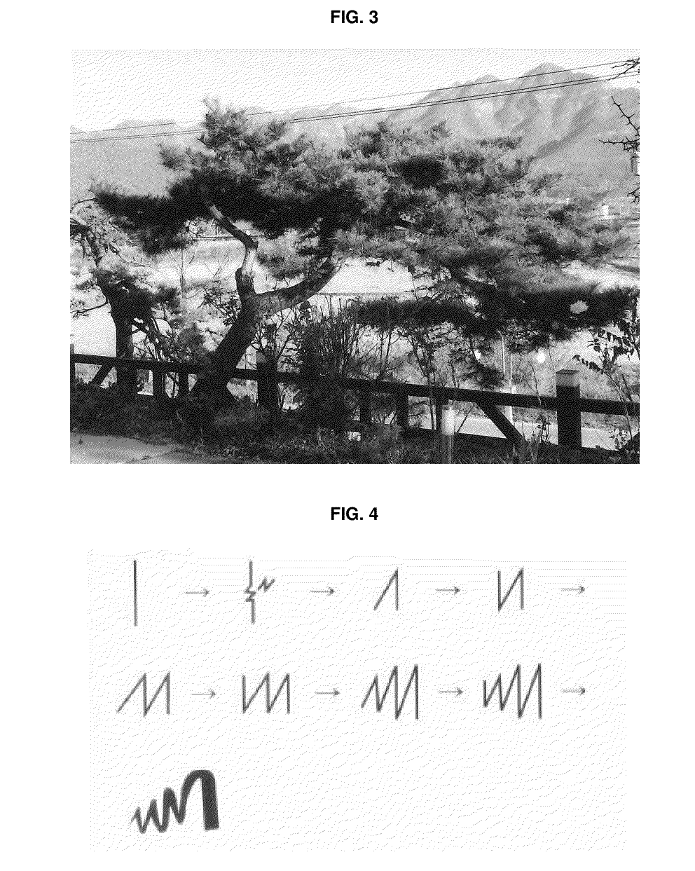

More particularly, referring to FIGS. 1 to 3, an ornamental tree having a branch shape which appears to be pressed by snow is formed according to a method including first pruning to prune branches while leaving downwardly growing branches among branches developed from horizontal branches of a sapling or adult tree; first branch growth inducing to downwardly induce growth of the downwardly growing branches left after the first pruning; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to downwardly induce growth of the left-side growing branches left after the third pruning; fourth pruning to prune branches while leaving upwardly growing branches among branches developed from the downwardly growing branches growth-induced by the third branch growth inducing; and fourth branch growth inducing to upwardly induce growth of the upwardly growing branches left after the fourth pruning.

The ornamental tree having a branch shape which appears to be pressed by snow has beautiful branches which appear to naturally grow after being shaped in a pressed and inclined state by the weight of snow and then re-pressed by the weight of snow. In this case, rings are hung on branches to narrow angles of branches. Instead of rings, binding lines or copper wires may be used. In some cases, rubber bands may be used. To induce directions of thick branches, instruments may used. Pruning is carried out two times a year. When trees are in a good nutrient state, pruning is carried out in the last ten days of May or before the first ten days of June. Second pruning is carried out before the last ten days of July. To sharply express angles of branches, branches are cut leaving end portions of approximately 3 cm. To maintain a curve shape, branch end portions of approximately 3 cm are cut. When one-half or more of branches are cut, scals and pine wood nematodes must be controlled. When two-thirds or more of branches are cut, a growth activator must be used. The disease prevention by insects and the growth activator use are applied merely to pine trees and are not required in the other trees.

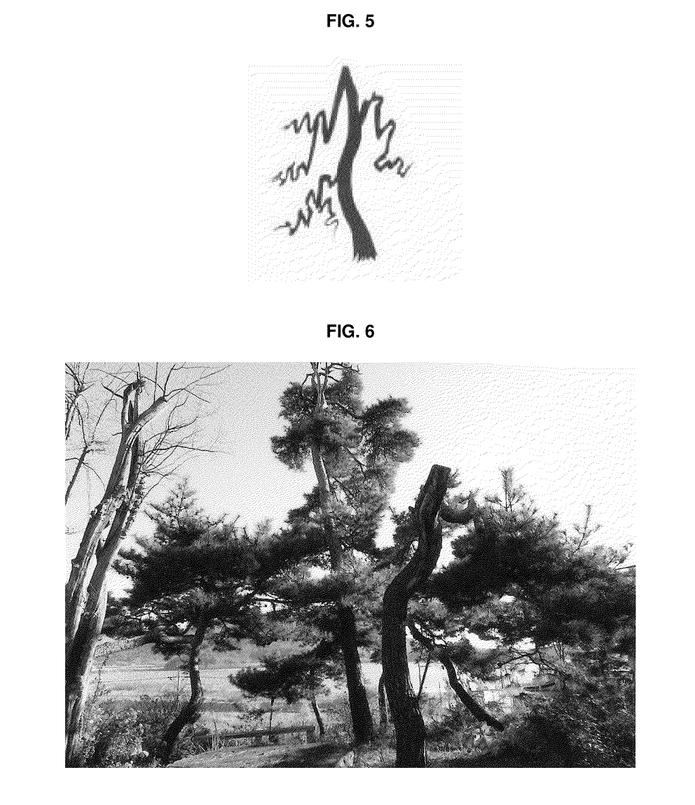

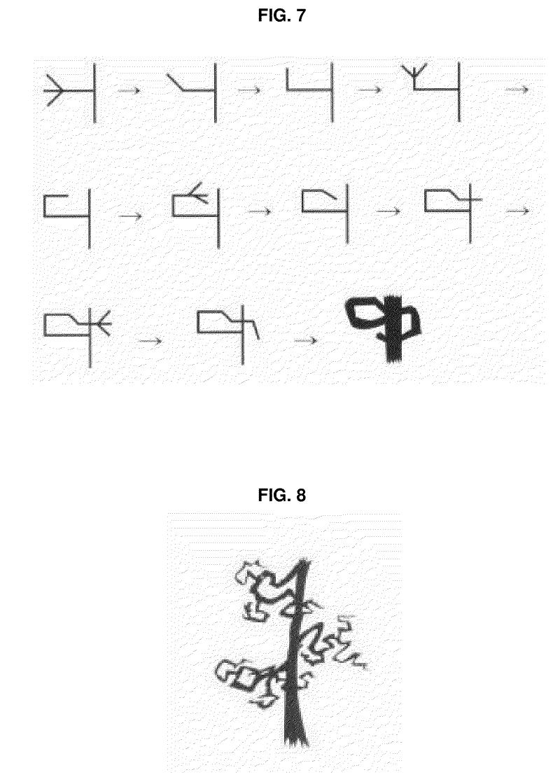

Referring to FIGS. 4 to 6, an ornamental tree having a branch shape which appears to be struck by lightning is formed according to a method including first pruning to prune branches while leaving branches growing to the left side of branches developed from vertical branches of a sapling or adult tree; first branch growth inducing to downwardly induce growth of the left-side growing branches left after the first pruning; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to downwardly induce growth of the left-side growing branches left after the third pruning; fourth pruning to prune branches while leaving left-side growing branches among branches developed from the downwardly growing branches growth-induced by the third branch growth inducing; and fourth branch growth inducing to upwardly induce growth of the left-side growing branches left after the fourth pruning.

The ornamental tree having a branch shape which appears to be struck by lightning has beautiful branches which appear to be revived by the laws of nature and viability after being struck by lightning. Here, growth of branches is induced by fixing branch shapes with binding lines and electric wires. According to angles of branches, branches collecting nutrients of a tree rapidly become thick. Therefore, considering the shape of a tree after branches grow, branches may be cut into not only one joint but also two or three joints. To sharply express angles of branches, branches are cut leaving end portions of approximately 3 cm of the branches. To maintain curve shapes or soft lines, branch end portions of approximately 0.5 cm are pruned. After pruning, pesticides and a wetting agent are used together. In addition, scals and pine wood nematodes must be controlled.

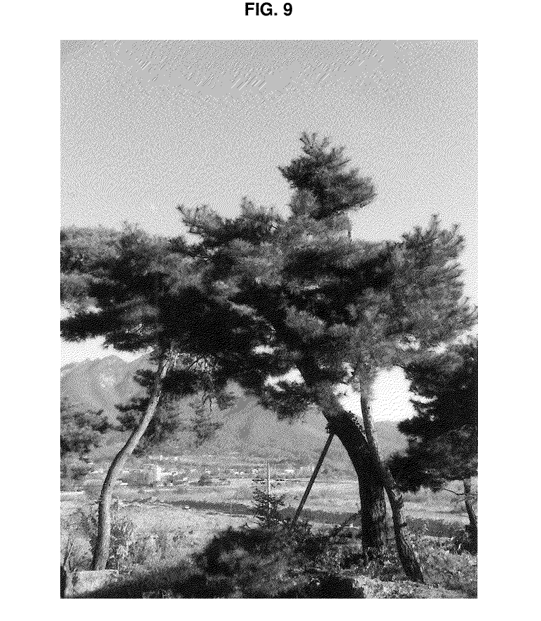

In addition, referring to FIG. 7 to FIG. 9, an ornamental tree having a branch shape which appears to be bent by the wind is formed according to a method including first pruning to prune branches while leaving upwardly growing branches among branches developed from horizontal branches of a sapling or adult tree; first branch growth inducing to upwardly induce growth of the upwardly growing branches left after the first pruning; second pruning to prune branches while leaving branches growing to the right side among branches developed from the upwardly growing branches growth-induced by the first branch growth inducing; second branch growth inducing to induce growth of the right-side growing branches left after the second pruning to the right side; third pruning to prune branches while leaving downwardly growing branches among branches developed from the right-side growing branches growth-induced by the second branch growth inducing; third branch growth inducing to downwardly induce growth of the downwardly growing branches left after the third pruning; fourth pruning to prune branches while leaving branches growing to the right side among branches developed from the downwardly growing branches growth-induced by the third branch growth inducing; and fourth branch growth inducing to induce growth of the right-side growing branches left after the fourth pruning to the right side.

The ornamental tree having a branch shape which appears to be bent by the wind has beautiful branches which appear to be not plucked and grow according to the laws of nature in spite of being bent by a gust of wind after being wetted by rain or being covered by snow by the seaside or by the river. In this case, growth of branches is induced using binding lines (when branches are not removed), electric wires (when branches are removed), or circular rubber bands (when branches are not removed). When it is desired to form protuberances at angular portions of branches, a tree is fertilized with a fertilizer. Such fertilization may be performed on trees two year old or older.

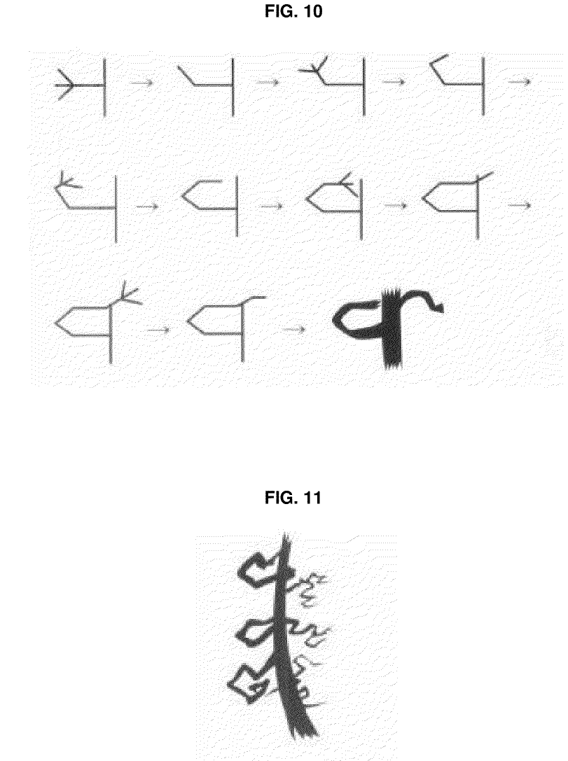

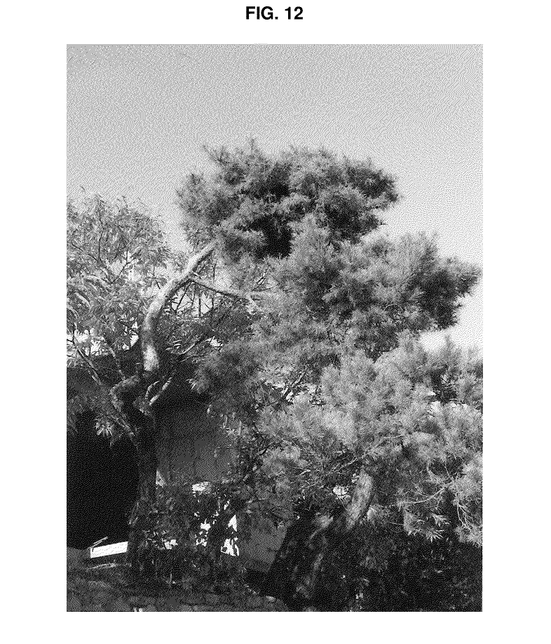

Referring to FIGS. 10 to 12, an ornamental tree having a branch, a direction of which appears to have been changed by the wind, is formed according to a method including first pruning to prune branches while leaving upwardly growing branches among branches developed from horizontal branches of a sapling or adult tree; first branch growth inducing to induce growth of the upwardly growing branches left after the first pruning in a leftwardly and upwardly inclined direction; second pruning to prune while leaving branches growing to the right side among branches developed from the leftwardly and upwardly inclined branches growth-induced by the first branch growth inducing; second branch growth inducing to induce growth of the right-side growing branches left after the second pruning in a rightwardly and upwardly inclined direction; third pruning to prune branches while leaving downwardly growing branches among branches developed from the rightwardly and upwardly inclined branches growth-induced by the second branch growth inducing; third branch growth inducing to induce growth of the downwardly growing branches left after the third pruning to the right side; fourth pruning to prune branches while leaving upwardly growing branches among branches developed from the right-side growing branches growth-induced by the third branch growth inducing; fourth branch growth inducing to induce growth of the upwardly growing branches left after the fourth pruning in a rightwardly and upwardly inclined direction; fifth pruning to prune branches while leaving downwardly growing branches among branches developed from the rightwardly and upwardly inclined branches growth-induced by the fourth branch growth inducing; fifth branch growth inducing to induce growth of the downwardly growing branches left after the fifth pruning to the right side; sixth pruning to prune branches while leaving downwardly growing branches among branches developed from the right-side growing branches growth-induced by the fifth branch growth inducing; sixth branch growth inducing to induce growth of the downwardly growing branches left after the sixth pruning in a rightwardly and downwardly inclined direction; seventh pruning to prune branches while leaving upwardly growing branches among branches developed from the rightwardly and downwardly inclined branches growth-induced by the sixth branch growth inducing; and seventh branch growth inducing to induce growth of the upwardly growing branches left after the seventh pruning to the right side.

The ornamental tree having a branch, a direction of which appears to have been changed by the wind has beautiful branches showing the laws of nature and challenge, which appear to grow in a direction of the wind after growing in the face of the wind blowing almost all day and then repeat growing in the face of a direction of the wind and growing in a direction of the wind. Here, branches are sequentially pruned in a previously pruned direction without a growth inducing step, as shown in a figure. When one-year-old tree is pruned later in the year, branches at bent portions are pruned leaving 2 cm of end portions of the branches. When one year tree is pruned in the first half and second half year, branches at bent portions are pruned leaving 3 cm of end portions of the branches. As a result, angles are formed in branches.

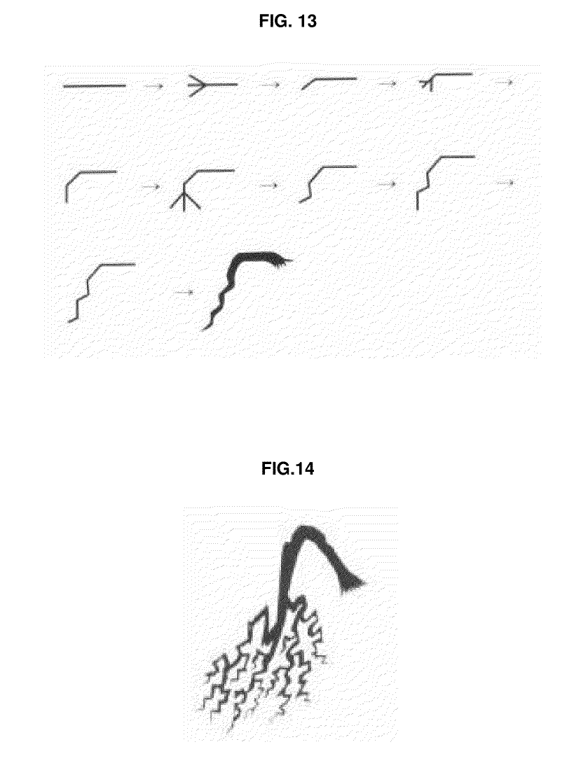

Referring to FIGS. 13 to 15, an ornamental tree having a branch shape which appears to grow on a cliff is formed according to a method including first pruning to prune branches while leaving downwardly growing branches among branches developed from horizontal branches of a sapling or adult tree; first branch growth inducing to induce growth of the downwardly growing branches left after the first pruning in a leftwardly and downwardly inclined direction; second pruning to prune branches while leaving branches growing to the right side among branches developed from the leftwardly and downwardly inclined branches growth-induced by the first branch growth inducing; second branch growth inducing to downwardly induce growth of the right-side growing branches left after the second pruning; third pruning to prune branches while leaving left-side growing branches among branches developed from the downwardly growing branches growth-induced by the second branch growth inducing; third branch growth inducing to induce growth of the left-side growing branches left after the third pruning in a leftwardly and downwardly inclined direction; fourth pruning to prune branches while leaving branches growing to the right side among branches developed from the leftwardly and downwardly inclined branches growth-induced by the third branch growth inducing; fourth branch growth inducing to downwardly induce growth of the right-side growing branches left after the fourth pruning; fifth pruning to prune branches while leaving left-side growing branches among branches developed from the downwardly growing branches growth-induced by the fourth branch growth inducing; and fifth branch growth inducing to induce growth of the left-side growing branches left after the fifth pruning in a leftwardly and downwardly inclined direction.

The ornamental tree having a branch shape which appears to grow on a cliff has unique and beautiful branches which appear to be exposed to a rainstorm blowing in an upper and lower direction and snow while growing toward an empty space to make their space. Here, when branches sagged by pruning are desired, branches are dried when leaf buds are formed and nutrient collection must be prevented. Branches at bent portions are pruned leaving 2 cm of end portions of the branches to well maintain branch shapes.

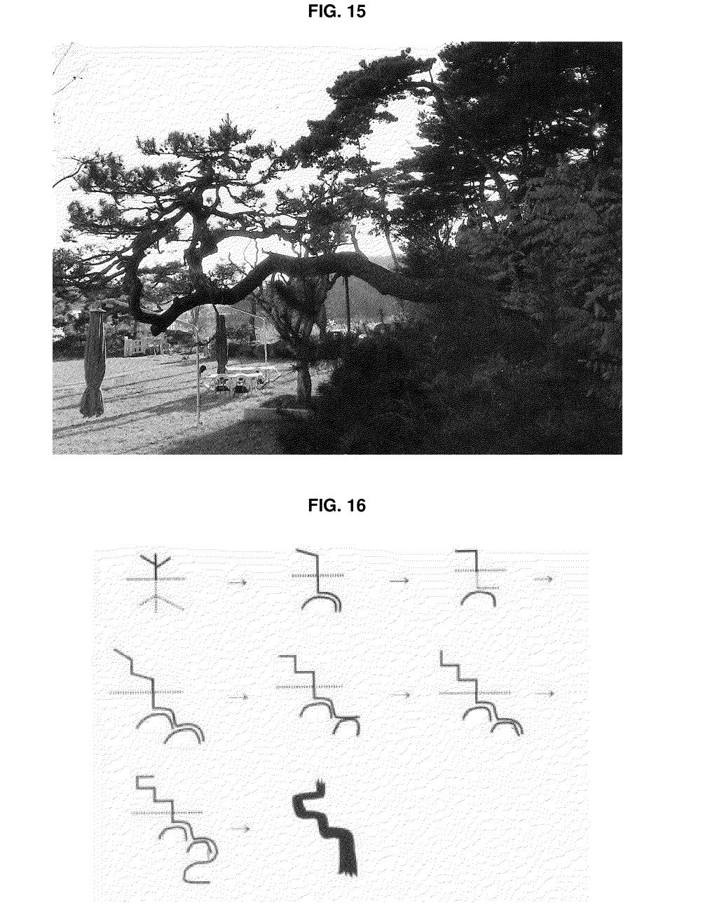

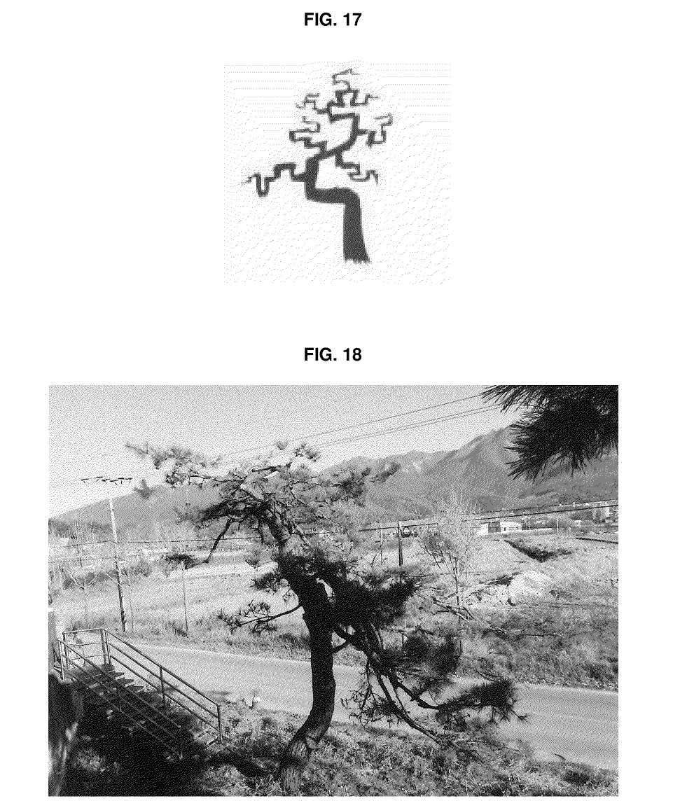

Referring to FIGS. 16 to 18, an ornamental tree having a branch shape which appears to grow on a rock is formed according to a method including first pruning to prune branches while leaving branches growing to the left side of branches developed from vertical branches of a sapling or adult tree; first branch growth inducing to induce growth of the left-side growing branches left after the first pruning to the left side; second pruning to prune branches while leaving upwardly growing branches among branches developed from the left-side growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to induce growth of the left-side growing branches left after the third pruning to the left side; fourth pruning to prune branches while leaving upwardly growing branches among branches developed from the left-side growing branches growth-induced by the third branch growth inducing; and fourth branch growth inducing to upwardly induce growth of the upwardly growing branches left after the fourth pruning.

The ornamental tree having a branch shape which appears to grow on a rock has beautiful and mysterious branches in which a stem appears to grow vertically and roots appear to expend under the ground and then, by obstacles, the stem appears to be bent in the opposite direction and roots appear to be bent over many years. Here, branches are pruned leaving 3 cm end portions of the branches to form beautiful angles. Growth of branches is induced using binding lines or electric wires. The thicknesses of the binding wires are proportional to the thickness of a tree. In a broadleaf tree, growth inducing is carried out when a moisture content of the tree is low. In a needleleaf tree, growth inducing is carried out when a moisture content of the tree is high. After growth inducing, a tree needs watering to maintain angles of branches. To make protuberances, a tree is excessively fertilized using compost or a fertilizer. The excessive nourishing may be carried out in a two-year-old tree or older.

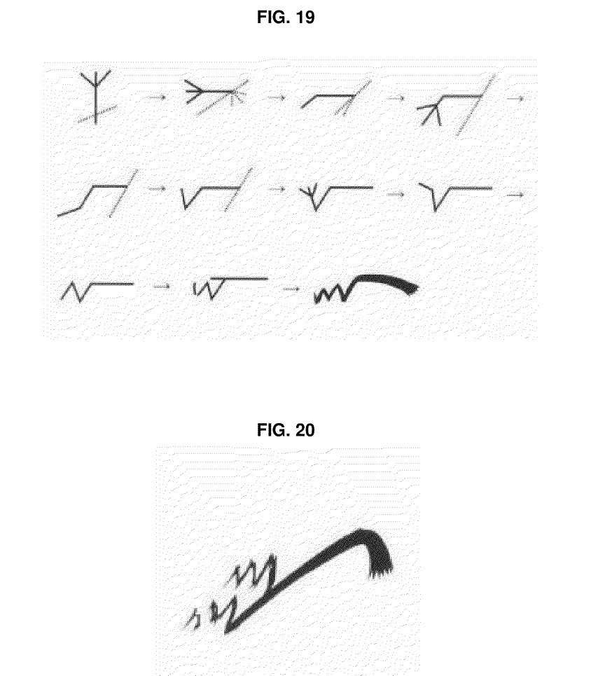

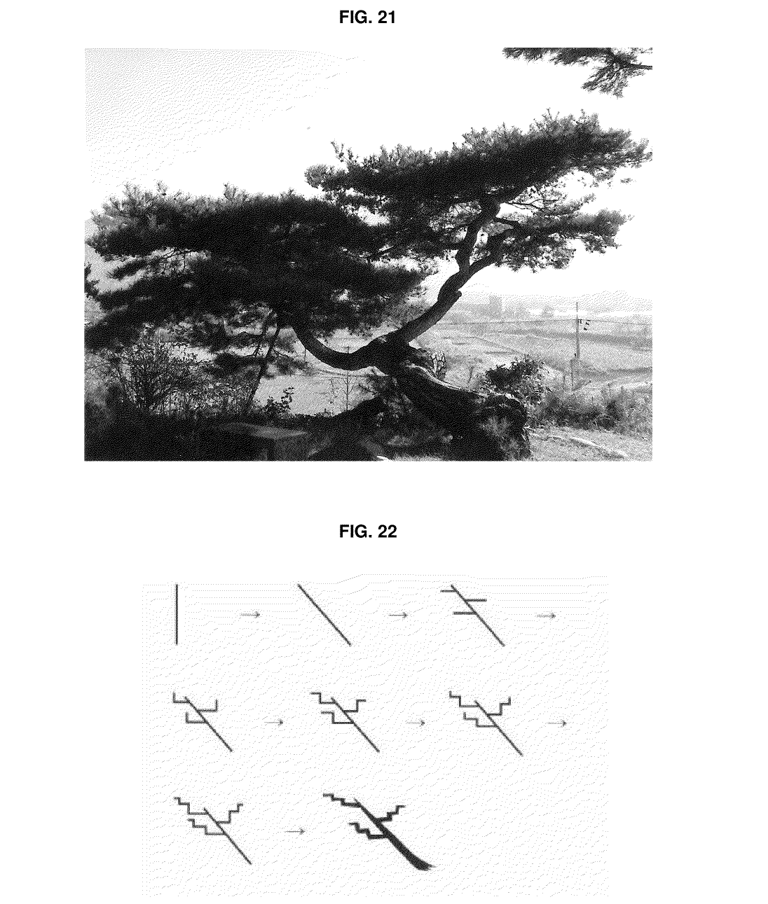

Referring to FIGS. 19 to 21, an ornamental tree having a branch shape which appears to grow in a landslide area is formed according to a method including first pruning to prune branches while leaving upwardly growing branches after inducing growth of branches developed from vertical branches of a sapling or adult tree in a leftwardly and downwardly inclined direction; first branch growth inducing to upwardly induce growth of the upwardly growing branches left after the first pruning; second pruning to prune branches while leaving left-side growing branches among branches developed from the upwardly growing branches growth-induced by the first branch growth inducing; second branch growth inducing to induce growth of the left-side growing branches left after the second pruning in a leftwardly and downwardly inclined direction; third pruning to prune branches while leaving upwardly growing branches among branches developed from the leftwardly and downwardly inclined branches growth-induced by the second branch growth inducing; and third branch growth inducing to upwardly induce growth of the upwardly growing branches left after the third pruning.

The ornamental tree having a branch shape which appears to grow in a landslide area expresses a beautiful and mysterious tree having marvelous viability, which appear to maintain life while barely taking roots after being carried off by a landslide due to sudden heavy rain. Growth of branches is induced in May when sap actively moves. Here, depending on the thickness of a tree, No. 2 to 8 wires are used. Video tapes are used to prevent burst of branches.

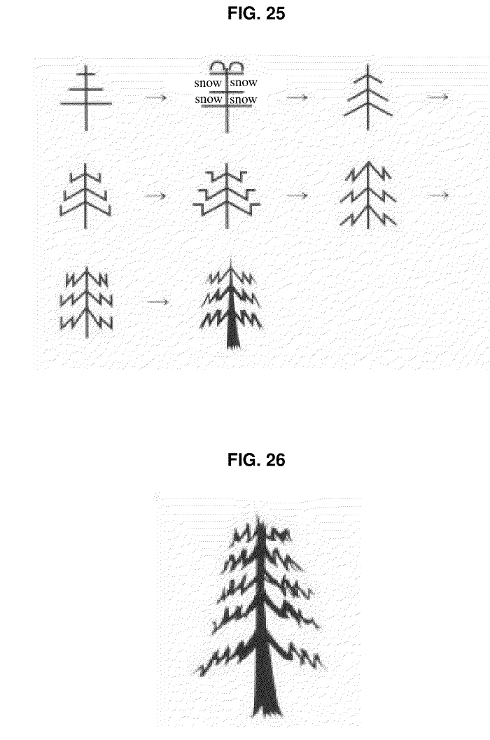

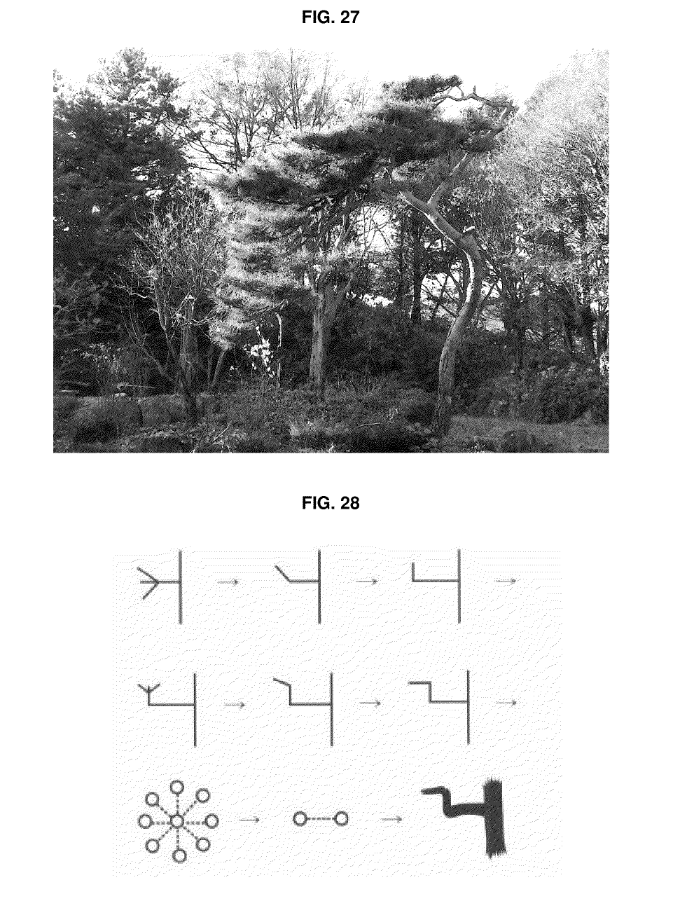

Referring to FIGS. 25 to 27, an ornamental tree having a branch shape which appears to sag due to heavy snow is formed according to a method including first pruning to prune branches while leaving downwardly growing branches after downwardly inducing growth of branches developed from vertical branches of a sapling or adult tree; first branch growth inducing to downwardly induce growth of the downwardly growing branches left after the first pruning; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving downwardly growing branches among branches developed from the upwardly growing branches growth-induced by the second branch growth inducing; third branch growth inducing to downwardly induce growth of the downwardly growing branches left after the third pruning; fourth pruning to prune branches while leaving upwardly growing branches among branches developed from the downwardly growing branches growth-induced by the third branch growth inducing; and fourth branch growth inducing to upwardly induce growth of the upwardly growing branches left after the fourth pruning.

The ornamental tree having a branch shape which appears to sag due to heavy snow has beautiful branches overcoming nature, which appear to be sagged by the weight of heavy snow and be fixed to sagged shapes, and new branches from which appear to repeat growing and being sagged by the weight of snow. To induce growth of branches in an upper and lower direction, wires are attached to desired portions of branches. Alternatively, branches are lowered using a string or pulling instrument. The growth-induced branches naturally grow upwards. When the growth-induced branches lean down, growth of branches is induced. When the growth-induced branches grow upwards, the branches are nourished with nutrients and water.

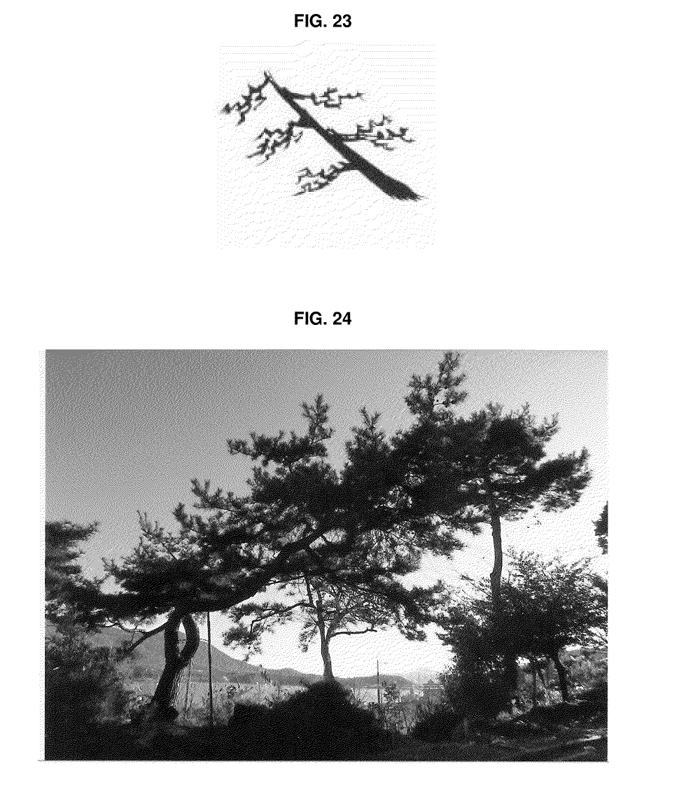

Referring to FIGS. 22 to 24, an ornamental tree having a branch shape which appears to grow out of a narrow space in which trees competitively grow or has beautiful branches which appear to grow toward an empty space in a sidewardly sagged state, not upwardly growing, while competing with other trees or branches to occupy a space during photosynthesis. Here, to induce growth of a tree and branches, a tree and branches are fixed with piles and rebar. A formation method of angles in branches and a tree is the same as described above. A formation method of protuberances in branches and a tree also is the same as described above.

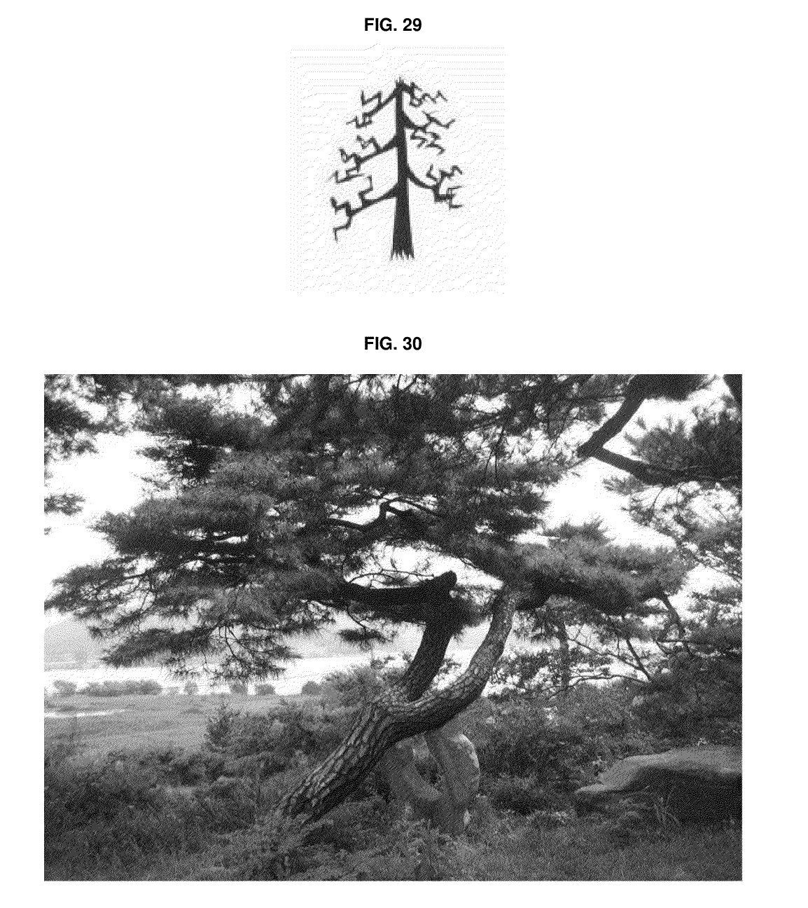

Referring to FIGS. 28 to 30, an ornamental tree having [symbol] -shape or [symbol] -shape branches weakening viability of trees is formed by pruning in a [symbol] -shape or [symbol] -shape to prevent overgrowth of a tree, to delay the rate of growth, to prevent development of crossing branches by halving sap flow, and to promote the growth of a stem using an absolute method in an assemble state, such that branches beautifully and mysteriously grow over many years. Here, in a two-year-old tree or older, branches may be inwardly pruned. Branches growing in an upper or lower direction may be used.

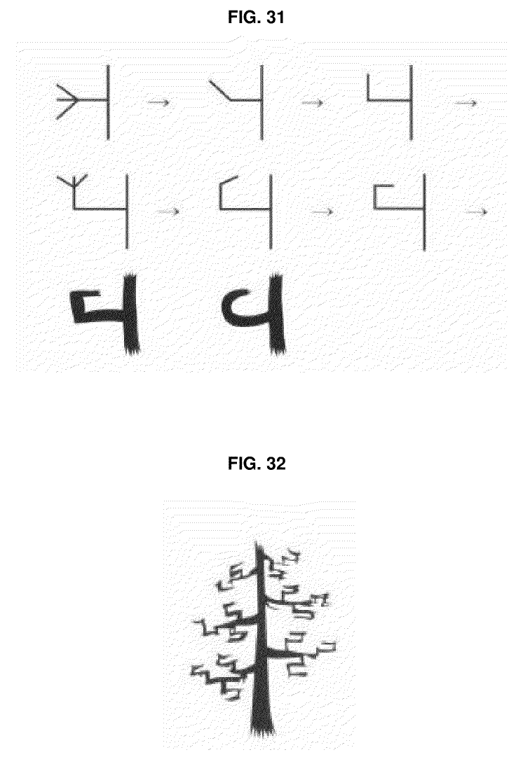

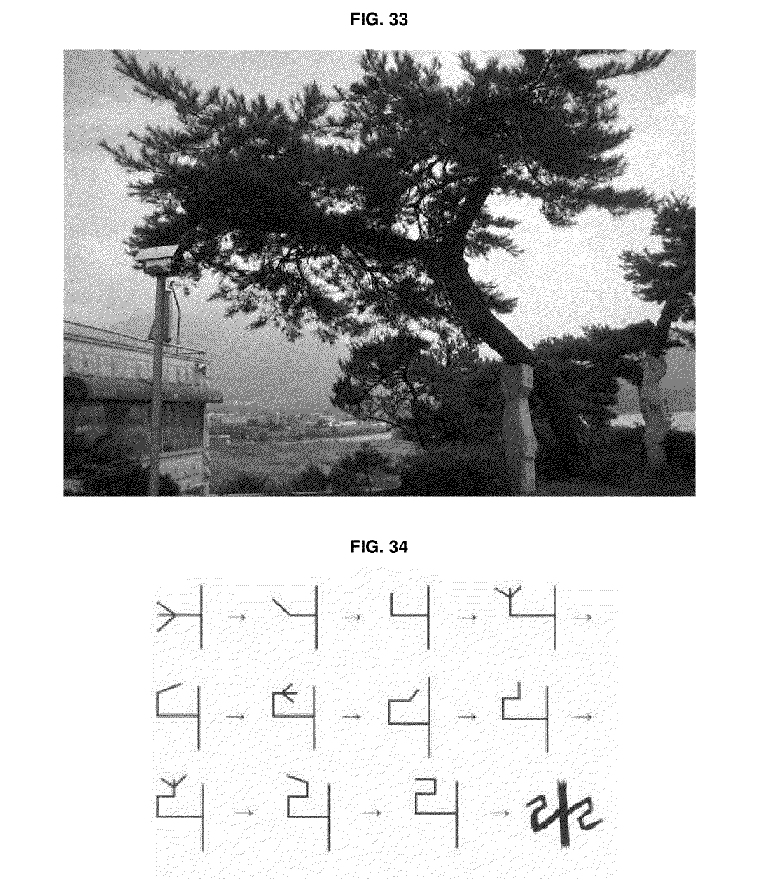

Referring to FIGS. 31 to 33, an ornamental tree having [symbol] -shape branches, in which sap flow is stopped, has beautiful branches in which sap flow is trained to approximately two-thirds and growth of which is stopped by growth inducing in a [symbol] -shape, to prevent development of crossed branches and lose of branch arrangement of trees and to form lumps through excessive nourishment. Here, branches may be pruned to maintain horizontality as much as possible. Downwardly sagged branches, upwardly growing branches, or the like may be horizontally twisted with wires. To reduce wounds of branches, thick branches may be twisted using tourniquets, and thin branches may be twisted using paraffin paper.

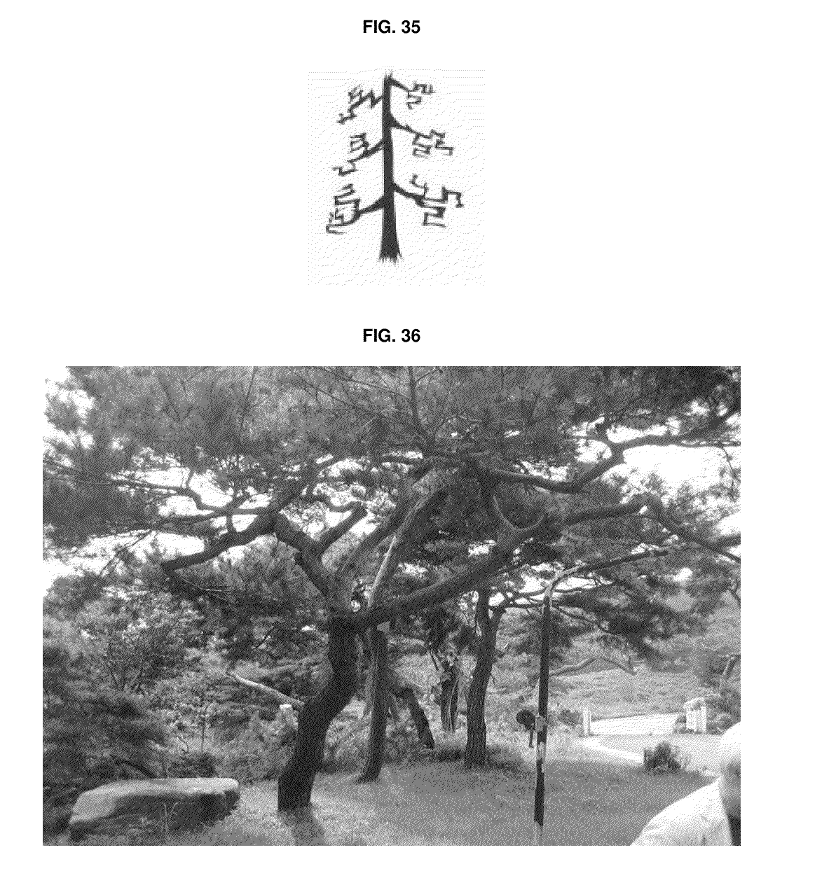

Referring to FIGS. 34 to 36, an ornamental tree having [symbol] -shape branches in which nutrients are collected in a stem is a tree in which sap flow is trained to approximately four-fifths and nutrients are collected in a stem by growth inducing in a [symbol] -shape, to make lumps or protuberances. Branch shapes are determined in an S-shape or [symbol] -shape. This method is a pruning method to almost stop growth of terminal leaflets although sap flows and to enlarge the base of a tree in a short time. Here, to grow a tree in a short time on a commercial scale, a tree may be nourished with a fertilizer and pruning may be carried out two times a year. To make a curve shape such as an S-shape, pruned branches are very closely cut, not leaving end portions of the branches, and then sufficient water is provided thereto. To maintain a [symbol] -shape, branches are pruned leaving 2 cm to 3 cm end portions of the branches, considering the thickness and lengths of branches. Here, supply of water and nutrients is reduced.

Although certain contents of the present invention were described in detail above, those skilled in the art will appreciate that the description is merely to explain preferable embodiments and the spirit of the present invention is not limited to the embodiments described in the present specification. Accordingly, the substantial scope of the present invention is defined only to the following claims and equivalents thereof.

As apparent from the above description, a method of forming an ornamental tree by pruning and inducing growth of branches according to the present invention may form a beautifully shaped tree, may prevent development of crossing branches, may prevent branches from bending by heavy snow, may prevent damage by a gust of wind or a typhoon, may prevent disease and harmful insects by smooth air, may aid migration and settlement of birds being exterminators of harmful insects, may help branches to absorb nutrients and may prevent development of weak branches by increasing a light transmission ratio, may help trees to be easily moved, may help trees to be simply moved, may reduce tree care costs, may provide expensive trees, may save tree transportation costs, and may reduce problems of transplanted trees due to development of minor roots, and, accordingly, may be industrially used in landscaping.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of forming an ornamental tree by pruning and inducing growth of branches, the method comprising first pruning to prune branches while leaving branches toward any one direction or alternately leaving branches toward crossing directions after inducing growth of branches developed from horizontal, vertical or inclined branches of a sapling or adult tree to an original direction or to any one direction; first branch growth inducing to downwardly induce growth of the downwardly growing branches left after the first pruning; second pruning to prune branches while leaving branches in one direction of branches developed from branches toward one direction growth-induced in the first branch growth; second branch growth inducing to induce growth of the left branches in any one of upper, lower, front, rear, left and right directions after the second pruning; and sequentially repeating the second pruning and the second branch growth inducing one time or more after the second branch growth inducing, wherein the ornamental tree is an ornamental tree having a branch shape which appears to be pressed by snow, an ornamental tree having a branch shape which appears to be struck by lightning, an ornamental tree having a branch shape which appears to be bent by the wind, an ornamental tree having a branch, a direction of which appears to have been changed by the wind, an ornamental tree having a branch shape which appears to grow on a cliff, an ornamental tree having a branch shape which appears to grow on a rock, an ornamental tree having a branch shape which appears to grow in a landslide area, an ornamental tree having a branch shape which appears to grow out of a narrow space in which trees competitively grow, an ornamental tree having a branch shape which appears to sag due to heavy snow, an ornamental tree having a [symbol] -shape or [symbol] -shape branch, viability of which appears to be weakened, or an ornamental tree having a [symbol] -shape, sap flow of which appears to be stopped or an ornamental tree having a [symbol] -shape branch of which nutrients appear to be collected in a stem.

2. The method according to claim 1, wherein the ornamental tree having a branch shape which appears to be pressed by snow is formed according to a method comprising first pruning to prune branches while leaving downwardly growing branches among branches developed from horizontal branches of a sapling or adult tree; first branch growth inducing to induce growth of the other branches toward one direction left after the first pruning in any one of upper, lower, front, rear, left and right directions; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to downwardly induce growth of the left-side growing branches left after the third pruning; fourth pruning to prune branches while leaving upwardly growing branches among branches developed from the downwardly growing branches growth-induced by the third branch growth inducing; and fourth branch growth inducing to upwardly induce growth of the upwardly growing branches left after the fourth pruning.

3. The method according to claim 1, wherein the ornamental tree having a branch shape which appears to be struck by lightning is formed according to a method comprising first pruning to prune branches while leaving branches growing to a left side of branches developed from vertical branches of a sapling or adult tree; first branch growth inducing to downwardly induce growth of the left-side growing branches left after the first pruning; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to downwardly induce growth of the left-side growing branches left after the third pruning; fourth pruning to prune branches while leaving left-side growing branches among branches developed from the downwardly growing branches growth-induced by the third branch growth inducing; and fourth branch growth inducing to upwardly induce growth of the left-side growing branches left after the fourth pruning.

4. The method according to claim 1, wherein the ornamental tree having a branch shape which appears to be bent by the wind is formed according to a method comprising first pruning to prune branches while leaving upwardly growing branches among branches developed from horizontal branches of a sapling or adult tree; first branch growth inducing to upwardly induce growth of the upwardly growing branches left after the first pruning; second pruning to prune branches while leaving branches growing to a right side among branches developed from the upwardly growing branches growth-induced by the first branch growth inducing; second branch growth inducing to induce growth of the right-side growing branches left after the second pruning to the right side; third pruning to prune branches while leaving downwardly growing branches among branches developed from the right-side growing branches growth-induced by the second branch growth inducing; third branch growth inducing to downwardly induce growth of the downwardly growing branches left after the third pruning; fourth pruning to prune branches while leaving branches growing to the right side among branches developed from the downwardly growing branches growth-induced by the third branch growth inducing; and fourth branch growth inducing to induce growth of the right-side growing branches left after the fourth pruning to the right side.

5. The method according to claim 1, wherein the ornamental tree having a branch, a direction of which appears to have been changed by the wind, is formed according to a method comprising first pruning to prune branches while leaving upwardly growing branches among branches developed from horizontal branches of a sapling or adult tree; first branch growth inducing to induce growth of the upwardly growing branches left after the first pruning in a leftwardly and upwardly inclined direction; second pruning to prune while leaving branches growing to a right side among branches developed from the leftwardly and upwardly inclined branches growth-induced by the first branch growth inducing; second branch growth inducing to induce growth of the right-side growing branches left after the second pruning in a rightwardly and upwardly inclined direction; third pruning to prune branches while leaving downwardly growing branches among branches developed from the rightwardly and upwardly inclined branches growth-induced by the second branch growth inducing; third branch growth inducing to induce growth of the downwardly growing branches left after the third pruning to the right side; fourth pruning to prune branches while leaving upwardly growing branches among branches developed from the right-side growing branches growth-induced by the third branch growth inducing; fourth branch growth inducing to induce growth of the upwardly growing branches left after the fourth pruning in a rightwardly and upwardly inclined direction; fifth pruning to prune branches while leaving downwardly growing branches among branches developed from the rightwardly and upwardly inclined branches growth-induced by the fourth branch growth inducing; fifth branch growth inducing to induce growth of the downwardly growing branches left after the fifth pruning to the right side; sixth pruning to prune branches while leaving downwardly growing branches among branches developed from the right-side growing branches growth-induced by the fifth branch growth inducing; sixth branch growth inducing to induce growth of the downwardly growing branches left after the sixth pruning in a rightwardly and downwardly inclined direction; seventh pruning to prune branches while leaving upwardly growing branches among branches developed from the rightwardly and downwardly inclined branches growth-induced by the sixth branch growth inducing; and seventh branch growth inducing to induce growth of the upwardly growing branches left after the seventh pruning to the right side.

6. The method according to claim 1, wherein the ornamental tree having a branch shape which appears to grow on a cliff is formed according to a method comprising first pruning to prune branches while leaving downwardly growing branches among branches developed from horizontal branches of a sapling or adult tree; first branch growth inducing to induce growth of the downwardly growing branches left after the first pruning in a leftwardly and downwardly inclined direction; second pruning to prune branches while leaving branches growing to a right side among branches developed from the leftwardly and downwardly inclined branches growth-induced by the first branch growth inducing; second branch growth inducing to downwardly induce growth of the right-side growing branches left after the second pruning; third pruning to prune branches while leaving left-side growing branches among branches developed from the downwardly growing branches growth-induced by the second branch growth inducing; third branch growth inducing to induce growth of the left-side growing branches left after the third pruning in a leftwardly and downwardly inclined direction; fourth pruning to prune branches while leaving branches growing on the right side among branches developed from the leftwardly and downwardly inclined branches growth-induced by the third branch growth inducing; fourth branch growth inducing to downwardly induce growth of the right-side growing branches left after the fourth pruning; fifth pruning to prune branches while leaving left-side growing branches among branches developed from the downwardly growing branches growth-induced by the fourth branch growth inducing; and fifth branch growth inducing to induce growth of the left-side growing branches left after the fifth pruning in a leftwardly and downwardly inclined direction.

7. The method according to claim 1, wherein the ornamental tree having a branch shape which appears to grow on a rock is formed according to a method comprising first pruning to prune branches while leaving branches growing to a left side of branches developed from vertical branches of a sapling or adult tree; first branch growth inducing to induce growth of the left-side growing branches left after the first pruning to the left side; second pruning to prune branches while leaving upwardly growing branches among branches developed from the left-side growing branches growth-induced by the first branch growth inducing; second branch growth inducing to upwardly induce growth of the upwardly growing branches left after the second pruning; third pruning to prune branches while leaving the left-side growing branches among branches developed from the upwardly growing branches growth-induced by the second branch growth inducing; third branch growth inducing to induce growth of the left-side growing branches left after the third pruning to the left side; fourth pruning to prune branches while leaving upwardly growing branches among branches developed from the left-side growing branches growth-induced by the third branch growth inducing; fourth branch growth inducing to upwardly induce growth of the upwardly growing branches left after the fourth pruning.

8. The method according to claim 1, wherein the ornamental tree having a branch shape which appears to grow in a landslide area is formed according to a method comprising first pruning to prune branches while leaving upwardly growing branches after inducing growth of branches developed from vertical branches of a sapling or adult tree in a leftwardly and downwardly inclined direction; first branch growth inducing to upwardly induce growth of the upwardly growing branches left after the first pruning; second pruning to prune branches while leaving left-side growing branches among branches developed from the upwardly growing branches growth-induced by the first branch growth inducing; second branch growth inducing to induce growth of the left-side growing branches left after the second pruning in a leftwardly and downwardly inclined direction; third pruning to prune branches while leaving upwardly growing branches among branches developed from the leftwardly and downwardly inclined branches growth-induced by the second branch growth inducing; and third branch growth inducing to upwardly induce growth of the upwardly growing branches left after the third pruning.

9. The method according to claim 1, wherein the ornamental tree having a branch shape which appears to sag due to heavy snow is formed according to a method comprising first pruning to prune branches while leaving downwardly growing branches after downwardly inducing growth of branches developed from vertical branches of a sapling or adult tree; first branch growth inducing to downwardly induce growth of the downwardly growing branches left after the first pruning; second pruning to prune branches while leaving upwardly growing branches among branches developed from the downwardly growing branches growth-induced by the first branch growth inducing; second branch growth inducing to upwardly induce growth of the upwardly growing branches left after the second pruning; third pruning to prune branches while leaving downwardly growing branches among branches developed from the upwardly growing branches growth-induced by the second branch growth inducing; third branch growth inducing to downwardly induce growth of the downwardly growing branches left after the third pruning; fourth pruning to prune branches while leaving upwardly growing branches among branches developed from the downwardly growing branches growth-induced by the third branch growth inducing; and fourth branch growth inducing to upwardly induce growth of the upwardly growing branches left after the fourth pruning.
